(19) United States
(12) Patent Application Publication
(10) Pub. No.: US 2019/0352587 A1
(43) Pub. Date: Nov. 21, 2019

(54) Method for Screening Malt for Brewing Red Beer

(71) Applicant: Jiangnan University, Wuxi (CN)

(72) Inventors: Feiyun ZHENG, Wuxi (CN); Dongdong LI, Wuxi (CN); Yongxian LI, Wuxi (CN); Chunfeng LIU, Wuxi (CN); Chengtuo NIU, Wuxi (CN); Jinjing WANG, Wuxi (CN); Qi LI, Wuxi (CN)

(21) Appl. No.: 16/524,335

(22) Filed: Jul. 29, 2019

Related U.S. Application Data
(63) Continuation of application No. PCT/CN2019/070407, filed on Jan. 4, 2019.

(30) Foreign Application Priority Data
Aug. 1, 2018 (CN) 201810862889.2

(51) Int. Cl. C12C 12/00; G01N 21/29; C12C 1/18

(52) U.S. Cl. CPC C12C 12/00; C12C 1/18; G01N 21/29

(57) ABSTRACT

The present disclosure discloses a method for screening malt for brewing red beer, and belongs to the field of beer brewing. The method takes different kinds of malt samples as examples, and after whole malt mashing and dilution, mashed wort is diluted with water to a chroma value of 50-80 EBC; and when the red intensity of the mashed wort having a chromatic value of 50-80 EBC is 0.209-0.289, the measured malt can be fermented and brewed into red beer. The method can screen malt for red beer brewing simply and quickly, is of important practical significance for guiding the production of red beer, and lays an important foundation for further brewing red beer with different malt.

### TECHNICAL FIELD

The disclosure herein relates to a method for screening malt for brewing red beer, belonging to the field of beer brewing.

### BACKGROUND

Beer is a low-alcohol fermented wine made from malt, water and hops as raw materials and fermented by yeast. According to the difference in sterilization processes, beer can be divided into pasteurized beer, draft beer and fresh beer; according to the difference in color, beer can be divided into light beer, colored beer and dark beer; and according to the difference in characteristics of raw materials, beer can be divided into ordinary beer and special beer. Special beer refers to beer with a special style due to changes in raw materials and processes. Red beer is classified as special beer because its body is in red color and has a strong appearance attractiveness, which is completely different from ordinary light beer. Red beer contains rich carbon dioxide, has fine foam, is long-lasting hanging cup and mellow in taste, and has an obvious caramel malt flavor. Because of its uniqueness and individuality in color, taste and flavor as well as multiple nutrients, red beer is favored by many consumers.

Malt is one of raw materials for beer production. Beer produced by different species of malt has obvious difference in color, flavor and taste. The national industry standard only divides malt into four types including light malt, caramel malt, dark malt and black malt. As an important appearance characteristic of beer, color directly affects people's perception of its quality. Different malts can be combined with light malt to make beer with different colors. Among them, brewing of the red beer is conducted by selecting light malt and dark special malt of suitable chroma according to different proportions and fermenting. However, selection of the range of malt for matching has no uniform standard, and only relies on some production experience, lacking practical theoretical basis. At the same time, the definition of red malt is lacking and has not been specifically refined to form an industry standard. Color is one of the primary appearance characteristics of red beer, which is the key determined by the production raw material malt itself, followed by the rationality of a brewing process and the operability of equipment. The chroma index is determined by making malt into wort. Although the chroma index is widely used, it can only measure the apparent color of the whole wort, and cannot determine the specific hue composition. This leads to some shortcomings in the guidance of red beer.

The malt species circulating in the market vary widely, and chromatic values range from 4-5 EBC to over thousand EBC. Wort made from different species of malt has obviously different colors, including yellow, orange, red, brown, black and other colors. The International Commission on Illumination presents a CIE Lab color model with five parameters, namely L*, a*, b*, C*, and h, where L*(0-100) represents brightness, specifically L* is 0 for black and is 100 for white; a* is positive for red, and a* is negative for green; b* is positive for yellow, and b* is negative for blue. This color model fits well with the human eye's perception of color. By using the CIE Lab color model parameters, it is possible to compare not only the color of the beer, but also the difference in the internal hue of different beer, and to take into account the relationship between the appearance color and the internal hue of the beer.

However, there has not yet been a systematic screening method for malt for brewing red beer. The screening of malt in the brewing process of red beer still relies on experience or a large number of tests, which is time consuming and laborious, and prone to deviation.

### SUMMARY

The present disclosure is directed to a method for screening malt for brewing red beer, laying an important foundation for further brewing red beer with different malt.

The present disclosure provides a method for screening malt for brewing red beer, including the following steps:

(1) saccharifying malt to prepare mashed wort;

(2) diluting the mashed wort with water to a chromatic value of 50-80 EBC, and screening out the mashed wort with a red intensity of 0.209-0.289, where the corresponding malt is the malt for brewing the red beer; and

the red intensity is a ratio of parameters a* to b* in a CIE Lab color model.

The measuring method of CIE Lab color model parameters is provided by the American Society of Brewing Chemists (ASBC), which is mainly used to determine color model parameters L*, a*, b*, C*, and h, and is combined with an RAL K7 color card to carry out color comparison in a TILO standard light source color assessment cabinet, to obtain the CIE Lab color parameters and corresponding color descriptions of many species of malt.

Further, a method for preparing the mashed wort in step (1) includes the following steps: crushing malt; taking and adding crushed malt grist to a congress mashing instrument; carrying out heat preservation at 40-50° C. for 20-50 min, heating to 65-80° C., carrying out heat preservation for 50-90 min, and cooling to room temperature; and adding water and filtering to obtain the mashed wort.

Further, a method for preparing the mashed wort in step (1) preferably includes the following steps: crushing malt; taking and adding crushed malt grist to a congress mashing instrument; carrying out heat preservation at 45° C. for 30 min, heating to 70° C., carrying out heat preservation for 60 min, then cooling to room temperature; and adding water and filtering to obtain the mashed wort.

Further, in the process of preparing the mashed wort in step (1), the heating rate is 1° C./min.

Further, when the mashed wort is diluted with water to chromatic values of 50, 60, 70 and 80 EBC respectively, the red intensity of the diluted mashed wort with the chromatic values of 50, 60, 70 and 80 EBC is determined respectively, and if two or more of four red intensity values fall within a range of 0.209-0.289, the corresponding malt is the malt for brewing the red beer.

The present disclosure further provides a method for brewing red beer, including proportioning malt, preparing mashed wort, and inoculating beer yeast for fermentation, where the malt proportioning is carried out by mixing special malt with light malt according to different proportions, so that the mashed wort has a chromatic value of 50-80 EBC and a red intensity of 0.209-0.289; and the red intensity is a ratio of parameters a* to b* in a CIE Lab color model.

Further, in the method for brewing red beer, the special malt is the malt screened by the method for screening malt for brewing red beer.

Further, in the method for brewing red beer, fermentation steps are as follows: adding proportionally mixed malt grist to 48° C. water, where raw material to water ratio is 1:4.5 (g/mL); during mashing, carrying out heat preservation at 48° C. for 30 min, heating to 63° C. and carrying out heat preservation for 60 min, heating to 72° C. and carrying out heat preservation for 20 min, and finally heating to 78° C. and carrying out heat preservation for 10 min; filtering the wort after mashing; boiling the filtered wort for 70 min, and adding hops during boiling; carrying out secondary filtration after boiling; adding a right amount of water to the filtered wort, and detecting and adjusting the wort concentration by using an Abbe refractometer, so that the concentration of the wort is adjusted to 11° Bx, where the beer yeast inoculation amount at the fermentation start is 1×10⁷/mL mixed wort; and fermenting at 11° C. for 7 days.

Further, in the method for brewing red beer, the hops are added in three times, where ½ is added just after boiling, ¼ is added when boiling lasts for 30 min, and the remaining ¼ is added 10 min before boiling ends, and the total amount of the hops added is 0.3 g/L.

### Beneficial Effects of the Present Disclosure

The present disclosure provides the method for screening malt for brewing red beer, which can screen out malt for brewing red beer simply and quickly, is of important practical significance for guiding the production of red beer, and lays an important foundation for further brewing red beer with different malt.

### DETAILED DESCRIPTION

Method for determining chroma: Wort or a beer sample is diluted to a suitable multiple if it is dark in color. A stock solution or a clarified sample of the diluent is added to a cuvette having a width of 10 mm, zero calibration is carried out using distilled water, and the absorbance of the sample is determined at 430 nm. The wort chroma is equal to A₄₃₀*25*n, where n is a dilution factor. The malt chroma is equal to A₄₃₀*25*n*2-E, where n is the dilution factor, and E is the chroma of light malt used in the congress wort.

Mashing instrument: BGT-8A congress mashing instrument, BIOER Company

Mashing: 50 g of crushed malt grist is taken and added to the mashing instrument, heat-preserved at 45° C. for 30 min, then heated to 70° C. at a rate of 1° C./min, and heat-preserved for 60 min. The malt grist is put into ice water to reduce to normal temperature, water is added up to 450 g, and congress wort is obtained after filtering.

Fermentation process: The proportionally mixed malt grist is added to 48° C. water, where raw material to water ratio is 1:4.5 (g/mL). Mashing is carried out by carrying out heat preservation at 48° C. for 30 min, heating to 63° C. and carrying out heat preservation for 60 min, heating to 72° C. and carrying out heat preservation for 20 min, and finally heating to 78° C. and carrying out heat preservation for 10 min. The wort is filtered after mashing. The filtered wort is boiled for 70 min, and hops are added for three times during boiling, where ½ is added just after boiling, ¼ is added when boiling lasts for 30 min, the remaining ¼ is added 10 min before boiling ends, and the total amount of the hops added is 0.3 g/L. Secondary filtration is carried out after boiling. A right amount of water is added to the filtered wort, and the wort concentration is detected and adjusted by using an Abbe refractometer, so that the concentration of the final wort is adjusted to 11° Bx, where the beer yeast inoculation amount at the fermentation start is 1×10⁷/mL mixed wort. The wort is fermented at 11° C. for 7 days.

### Example 1 Analysis of Color Indexes of Commercially Available Malt

Malt products with different chroma values were selected as commercially available malt, and the color indexes of different species of malt were analyzed. The malt was mashed, and the chroma of the wort obtained by mashing of different malt was measured as shown in Table 1. The chroma of wort of special malt ranged from 65EBC to 453EBC. As the chroma of the wort of the malt increased, L* decreases continuously, indicating that the brightness kept darkening; a* gradually increased to a certain level and then decreased, b* was consistent with the trend of a*; and color saturation C*, hue angle h and color difference ΔE all showed the same variation trend as a* and b*.

TABLE 1
Chroma and CIE Lab parameters of wort of different species of malt

| Malt Species | Chroma/EBC | L* | a* | b* | C* | h | ΔE |
|---|---|---|---|---|---|---|---|
| Canadian Light malt | 5 | 95.821 | −1.345 | 12.757 | 12.827 | −1.466 | 96.676 |
| Yongshuntai Red Malt | 65 | 79.432 | 6.948 | 72.902 | 73.232 | 1.476 | 108.039 |
| Medium Crystal | 89 | 73.399 | 14.422 | 79.152 | 80.455 | 1.391 | 108.905 |
| Dark Crystal | 118 | 66.794 | 21.076 | 84.229 | 86.826 | 1.326 | 109.545 |
| Yongshuntai Crystal No. 1 | 132 | 64.826 | 23.121 | 86.097 | 89.147 | 1.308 | 110.225 |
| RedBack Malt | 136 | 63.274 | 24.208 | 87.034 | 90.338 | 1.300 | 110.293 |
| Malteurop Crystal No. 3 | 142 | 61.079 | 26.391 | 86.934 | 90.852 | 1.276 | 109.474 |
| Malteurop Crystal No. 2 | 202 | 51.255 | 32.626 | 85.572 | 91.581 | 1.207 | 104.948 |
| Gladfield Shepherds | 266 | 42.736 | 38.187 | 82.289 | 90.718 | 1.136 | 100.280 |
| Delight | | | | | | | |
| BEST special X | 271 | 42.620 | 36.173 | 83.285 | 90.801 | 1.161 | 101.171 |
| Castle Special B | 277 | 40.496 | 36.762 | 79.199 | 87.315 | 1.136 | 96.249 |
| Yongshuntai Crystal No. 2 | 326 | 36.046 | 38.848 | 76.427 | 85.733 | 1.101 | 93.002 |
| Gladfield Brown | 363 | 20.588 | 31.955 | 55.505 | 64.046 | 1.048 | 67.274 |
| Yongshuntai Light Coffee | 395 | 15.492 | 29.398 | 49.796 | 57.826 | 1.037 | 59.866 |
| Malteurop Light Coffee | 436 | 11.323 | 28.362 | 43.549 | 51.970 | 0.994 | 53.189 |
| Castle Light Coffee | 453 | 9.957 | 26.328 | 41.079 | 48.792 | 1.001 | 49.797 |

### Example 2 Screening of Malt for Brewing Red Beer

The red color of red beer that the human eye can recognize and accept should include orange red, tomato red and brown red. Tomato red is the brightest in the three red colors. Other red series (including oxide red, purple red, wine red, etc.) greatly reduce people's acceptance of red beer because of the dark color. Since the chroma of the wort of dark malt for brewing red beer is greater than the chroma of the wort of light malt, and beer brewed by the dark malt alone exhibits a darker color instead of a red color, factories often add light-colored basic malt to dark malt to make red beer. In order to clarify which malt can be combined with light malt to brew red beer, first the relationship between the chroma of the mashed wort of malt and the color of the mashed wort determined by the sensory evaluation is analyzed. Then, the relationship between the chroma of the mashed wort of malt and the red intensity index (a*/b*) of the mashed wort is analyzed. Finally, the relationship between the chroma and red intensity of the mashed wort of mixed malt (the combination of dark malt and light malt) and the color of the beer is analyzed, and intersections of the chroma and red intensity of the mashed wort used in the mashed wort displaying red and the beer displaying red after fermentation are screened, thereby determining the malt that can be used in combination with the light malt to brew red beer.

1. Analysis of the Relationship Between the Chroma of the Mashed Wort and the Color of the Mashed Wort Determined by Sensory Evaluation

First, the mashed wort was diluted by adding distilled water to different chromatic values (for example: 30, 40, 50, 60, 70, 80, 90, 100, 110, 120 and 130 EBC). The colors of the mashed wort diluted to different chromatic values were then observed to obtain change of the color displayed by the malt mashed wort with the chroma of the mashed wort. The determination of the color of the mashed wort was performed by a sensory evaluation team.

The diluted mashed wort was placed in a lamp box equipped with a D65 standard light source, and the sensory evaluation team compared the color of the diluted mashed wort under the irradiation of the D65 standard light source with colors in an RAL K7 color card. The comparison results are shown in Table 2.

As shown in Table 2, Yongshuntai Red Malt exhibits orange at 30-60 EBC. Medium Crystal malt exhibits orange at 30-60 EBC and red at 70-100 EBC. Yongshuntai Crystal No. 1, RedBack Malt, Malteurop Crystal No. 3 and Malteurop Crystal No. 2 exhibit orange at 30-50 EBC and red at 60 EBC or higher. Gladfield Shepherds Delight exhibits red within 40-120 EBC, and BEST special X and Yongshuntai Crystal No. 2 exhibit red at 50-120 EBC. Gladfield Brown exhibits orange at 30-40 EBC, red at 50-60 EBC, and brown at 70-110 EBC. Yongshuntai Light Coffee and Castle Light Coffee malt exhibit orange at 30 EBC, red at 40-50 EBC, and brown at 60-120 EBC. It can be seen that when the mashed wort of most malt is diluted to 30-130 EBC, the mashed wort can be red, but the chroma range of the mashed wort is different when orange red, tomato red and brown red are shown. Therefore, we call a red special malt red malt, of which the proportion of the mashed wort exhibiting red in the range of 30-130 EBC is higher than 50% and the color appearance is one of orange red, tomato red or brown red. From Table 2, red malt that meets the conditions includes Medium Crystal, Yongshuntai Crystal No. 1, RedBack Malt, Malteurop Crystal No. 3, Malteurop Crystal No. 2, Shepherds Delight, BEST special X, and Yongshuntai Crystal No. 2 malt.

TABLE 2
Results of coloration of diluted mashed solutions of various malts under fixed chroma

| Malt | Chroma/EBC | | | | | | | | | | |
|---|---|---|---|---|---|---|---|---|---|---|---|
| Species | 30 | 40 | 50 | 60 | 70 | 80 | 90 | 100 | 110 | 120 | 130 |
| Yongshuntai | Yellow | Dark | Light | Signal | No | No | No | No | No | No | No |
| Red Malt | orange | orange | red | orange | | | | | | | |
| | | | orange | | | | | | | | |
| Medium | Yellow | Yellow | Signal | Signal | Orange | Orange | Tomato | Tomato | No | No | No |
| Crystal | orange | orange | orange | orange | red | red | red | red | | | |
| Yongshuntai | Yellow | Dark | Signal | Orange | Orange | Tomato | Tomato | Tomato | Oxide | Oxide | Oxide |
| Crystal No. 1 | orange | orange | orange | red | red | red | red | red | red | red | red |
| RedBack | Yellow | Dark | Signal | Orange | Tomato | Tomato | Tomato | Brown | Brown | Brown | Purple |
| Malt | orange | orange | orange | red | red | red | red | red | red | red | red |
| Malteurop | Yellow | Dark | Signal | Orange | Orange | Tomato | Tomato | Tomato | Brown | Purple | Purple |
| Crystal No. 3 | orange | orange | orange | red | red | red | red | red | red | red | red |
| Malteurop | Yellow | Dark | Signal | Orange | Tomato | Tomato | Brown | Brown | Oxide | Purple | Purple |
| Crystal No. 2 | orange | orange | orange | red | red | red | red | red | red | red | red |
| Gladfield | Light | Orange | Orange | Tomato | Brown | Brown | Purple | Purple | Wine | Wine | Black |
| Shepherds | red | red | red | red | red | red | red | red | red | red | red |
| Delight | orange | | | | | | | | | | |
| BEST | Yellow | Light red | Orange | Orange | Tomato | Brown | Brown | Purple | Wine | Wine | Black |
| special X | orange | orange | red | red | red | red | red | red | red | red | red |
| Yongshuntai | Yellow | Dark | Orange | Tomato | Brown | Purple | Purple | Wine | Wine | Wine | Black |
| Crystal No. 2 | orange | orange | red | red | red | red | red | red | red | red | red |
| Gladfield | Light | Signal | Orange | Oxide | Brownish | Mahogany | Mahogany | Chocolate | Chocolate | Black | Black |
| Brown | red | orange | red | red | red | brown | brown | brown | brown | red | red |
| | orange | | | | | | | | | | |
| Yongshuntai | Signal | Oxide | Oxide | Chestnut | Chestnut | Mahogany | Mahogany | Chocolate | Chocolate | Gray | Gray |
| Light Coffee | orange | red | red | brown | brown | brown | brown | brown | brown | brown | brown |
| Castle Light | Signal | Oxide | Oxide | Chestnut | Chestnut | Chocolate | Chocolate | Chocolate | Gray | Gray | Signal |
| Coffee | orange | red | red | brown | brown | brown | brown | brown | brown | brown | black |

2. Relationship Between the Chroma of Wort and the Red Intensity Index (a*/b*) of the Wort

First, the mashed wort was diluted by adding distilled water to different chromatic values (for example: 30, 40, 50, 60, 70, 80, 90, 100, 110, 120 and 130 EBC). Then, the red intensity indexes (a*/b*) of the wort diluted to different chromatic values were measured to obtain the relationship between the chroma of the wort and the red intensity index (a*/b*) of the wort.

From Table 2, we can determine the chromatic value of the wort of which the sensory evaluation result is red. Combined with the data in Table 3, we can determine the red intensity corresponding to the chromatic value of the wort exhibiting red. The experimental results are shown in Table 3. Under the premise of being red, the red intensity interval of Medium Crystal malt is 0.286-0.363. For malt with a chroma of 118-207 EBC, when the chroma of the mashed wort is 60-100 EBC, the red intensity of the wort is 0.247-0.368. For malt with a chroma of 208-326 EBC, when the chroma of the mashed wort is 50-80 EBC, the red intensity range of the wort is 0.209-0.331.

For malt with a chroma of 118-207 EBC, when the chroma of the mashed wort is 50 EBC, the red intensity value of the wort is generally lower than that of the malt with a chroma of 208-326 EBC. Therefore, malt with a wort chroma of 50-80 EBC and a red intensity index of 0.209-0.331 was selected.

TABLE 3
Red intensity indexes of diluted mashed solutions of various malts under fixed chroma

| | Red intensity Index (a*/b*) | | | | | | | | | | |
|---|---|---|---|---|---|---|---|---|---|---|---|
| Malt Species | 30 | 40 | 50 | 60 | 70 | 80 | 90 | 100 | 110 | 120 | 130 |
| Yongshuntai Red Malt | 0.104 | 0.148 | 0.197 | 0.254 | 0.269 | ND | ND | ND | ND | ND | ND |
| Medium Crystal | 0.111 | 0.178 | 0.200 | 0.252 | 0.286 | 0.311 | 0.330 | 0.363 | ND | ND | ND |
| Yongshuntai Crystal | 0.100 | 0.157 | 0.205 | 0.251 | 0.283 | 0.316 | 0.341 | 0.368 | 0.388 | 0.410 | 0.418 |
| No. 1 | | | | | | | | | | | |
| RedBack Malt | 0.103 | 0.160 | 0.207 | 0.247 | 0.285 | 0.309 | 0.339 | 0.364 | 0.387 | 0.400 | 0.421 |
| Malteurop Crystal No. 3 | 0.108 | 0.163 | 0.203 | 0.257 | 0.296 | 0.327 | 0.359 | 0.361 | 0.389 | 0.412 | 0.441 |
| Malteurop Crystal No. 2 | 0.110 | 0.179 | 0.207 | 0.261 | 0.298 | 0.331 | 0.360 | 0.378 | 0.405 | 0.426 | 0.448 |
| Gladfield Shepherds | 0.135 | 0.177 | 0.212 | 0.263 | 0.298 | 0.330 | 0.355 | 0.384 | 0.410 | 0.432 | 0.450 |
| Delight | | | | | | | | | | | |
| BEST special X | 0.102 | 0.138 | 0.193 | 0.230 | 0.270 | 0.311 | 0.330 | 0.353 | 0.377 | 0.401 | 0.415 |
| Yongshuntai Crystal | 0.102 | 0.157 | 0.209 | 0.252 | 0.291 | 0.321 | 0.348 | 0.376 | 0.393 | 0.415 | 0.437 |
| No. 2 | | | | | | | | | | | |
| Gladfield Brown | 0.159 | 0.215 | 0.258 | 0.296 | 0.336 | 0.369 | 0.384 | 0.429 | 0.449 | 0.465 | 0.482 |
| Yongshuntai Light | 0.166 | 0.221 | 0.268 | 0.304 | 0.339 | 0.370 | 0.392 | 0.430 | 0.445 | 0.479 | 0.490 |
| Coffee | | | | | | | | | | | |
| Castle Light Coffee | 0.169 | 0.227 | 0.274 | 0.311 | 0.342 | 0.379 | 0.401 | 0.438 | 0.450 | 0.478 | 0.494 |

Note:
ND indicates that the sample cannot be obtained at this point for measurement.

3. Relationship Between the Color and Red Intensity of the Mashed Wort of Mixed Malt and the Color of Beer

In order to further verify whether the malt with the mashed wort chroma of 50-80 EBC and the red intensity index of 0.209-0.331 is suitable for brewing red beer, we selected the malt with the mashed wort chroma of 65-436 EBC to match with basic malt (light malt) according to different proportions for beer fermentation experiments, and measured the color change of the body in the whole fermentation process. As shown in Table 4, when the fermentation chroma is in the range of 50-79 EBC, the red intensity after fermentation is 0.213-0.302, and the prepared beer is bright red beer. The corresponding mashed wort of the mixed malt has a chroma of 48-76 EBC and a red intensity range of 0.204-0.289.

From the data in Table 2 and Table 3, it can be seen that the red intensity of the mashed wort exhibiting a red color system is 0.209-0.331, and accordingly, the chroma of the mashed wort is 50-80 EBC. From Table 4, when the beer is red after fermentation, the chroma of the mashed wort of the mixed malt is 48-76 EBC, and the red intensity value is 0.204-0.289. The intersection of the red intensity of the mashed wort in Table 3 and Table 4 is 0.209-0.289. Therefore, the mashed wort can be diluted with water to a chroma of 50-80 EBC, and then whether the red intensity of the mashed wort under the corresponding chroma is in the range of 0.209-0.289 is judged. When the diluted mashed wort has a chroma of 50-80 EBC and a corresponding red intensity of 0.209-0.289, the corresponding malt or malt mixture can be used for brewing red beer. When the mashed wort is diluted to chroma values of 50, 60, 70 and 80 EBC, respectively, if there are two or more than two chroma values with the corresponding red intensity values in the range of 0.209-0.289, it indicates that the malt is more suitable and it is easier to brew red beer. When the mashed wort is diluted to chroma values of 50, 60, 70 and 80 EBC, respectively, if there is only one or no chroma value with the corresponding red intensity value in the range of 0.209-0.289, it indicates that the malt is difficult to brew, and although it can be used for brewing red beer, the malt is not preferably used for brewing the red beer.

TABLE 4
Chroma, red intensity and coloration results after mashing and fermentation of malt

| | | | | | | | Red intensity |
|---|---|---|---|---|---|---|---|
| | | Mashing | | Red intensity | Fermentation | Fermentation | after |
| Malt | Proportion/% | chroma/EBC | Mashing color | after mashing | chroma/EBC | color | fermentation |
| Medium | 15 | 35 | Yellow orange | 0.128 | 33 | Signal orange | 0.142 |
| Crystal | 28 | 55 | Orange red | 0.225 | 57 | Tomato red | 0.222 |
| | 41 | 75 | Brown red | 0.289 | 79 | Brown red | 0.293 |
| | 54 | 95 | Purple red | 0.346 | 97 | Wine red | 0.343 |
| | 10 | 23 | Yellow orange | 0.110 | 29 | Yellow | 0.123 |
| | | | | | | orange | |
| Yongshuntai | 18 | 53 | Tomato red | 0.204 | 50 | Tomato red | 0.215 |
| Crystal No. 1 | 26 | 76 | Brown red | 0.274 | 74 | Brown red | 0.302 |
| | 34 | 98 | Purple red | 0.345 | 93 | Black red | 0.353 |
| | 9 | 44 | Signal orange | 0.184 | 44 | Orange red | 0.172 |
| RedBack Malt | 14 | 63 | Tomato red | 0.263 | 63 | Tomato red | 0.248 |
| | 19 | 67 | Brown red | 0.311 | 75 | Purple red | 0.313 |
| | 8 | 40 | Dark orange | 0.150 | 42 | Orange red | 0.174 |
| Malteurop | 13 | 62 | Tomato red | 0.260 | 63 | Brown red | 0.263 |
| Crystal No. 2 | 18 | 76 | Brown red | 0.307 | 78 | Purple red | 0.312 |
| | 23 | 88 | Wine red | 0.340 | 90 | Wine red | 0.346 |
| | 3.5 | 32 | Light red | 0.115 | 32 | Signal orange | 0.133 |
| | | | orange | | | | |
| Yongshuntai | 7.0 | 53 | Tomato red | 0.220 | 52 | Tomato red | 0.226 |
| Crystal No. 2 | 10.5 | 75 | Brown red | 0.304 | 72 | Wine red | 0.303 |
| | 14.0 | 93 | Wine red | 0.359 | 92 | Black red | 0.362 |
| | 3.5 | 27 | Yellow orange | 0.110 | 29 | Dark orange | 0.108 |
| Gladfield | 6.6 | 48 | Oxide red | 0.217 | 50 | Tomato red | 0.213 |
| Brown | 9.7 | 58 | Purple red | 0.279 | 59 | Purple red | 0.273 |
| | 12.8 | 74 | Wine red | 0.343 | 75 | Black red | 0.334 |
| Yongshuntai | 21 | 39 | Light red | 0.166 | 39 | Orange red | 0.174 |
| Red Malt | | | orange | | | | |
| | 41 | 62 | Tomato red | 0.245 | 64 | Tomato red | 0.275 |
| | 61 | 82 | Purple red | 0.317 | 86 | Purple red | 0.337 |
| | 81 | 117 | Black red | 0.399 | 118 | Black red | 0.419 |
| Gladfield | 4.5 | 37 | Light red | 0.143 | 35 | Light red | 0.153 |
| Shepherds | | | orange | | | orange | |
| Delight | 8.5 | 60 | Tomato red | 0.241 | 58 | Brown red | 0.257 |
| | 12.5 | 76 | Brown red | 0.307 | 77 | Purple red | 0.330 |
| | 16.5 | 96 | Wine red | 0.374 | 94 | Wine red | 0.379 |

Note:
In Table 4, “mashing chroma” is the chroma of the mashed wort of mixed malt, “mashing color” is the color of the body of the mashed wort of the mixed malt obtained by sensory evaluation, “red intensity after mashing” is the red intensity of the mashed wort of the mixed malt, “fermentation chroma” is the chroma of the body after fermentation, “fermentation color” is the color of the body after fermentation obtained by sensory evaluation, and “red intensity after fermentation” is the red intensity of the body after fermentation.

### Example 3 Verification of Screening Method

In order to determine whether the screening method has high accuracy and applicability, three special malts, i.e., Dark Crystal, Castle Special B and Malteurop Light Coffee malt, were selected herein for verification. The three malts were mashed according to the method described above, the mashed wort was diluted to chromatic values of 50, 60, 70 and 80 EBC, and the red intensity value of the diluted mashed wort in the range of 50-80 EBC was measured and calculated. The experimental results are shown in Table 5.

TABLE 5
Red intensity of three malts in the range of 50-80 EBC

| Malt Species | 50 EBC | 60 EBC | 70 EBC | 80 EBC |
|---|---|---|---|---|
| Dark Crystal | 0.191 | 0.224 | 0.260 | 0.290 |
| Castle Special B | 0.225 | 0.269 | 0.283 | 0.321 |
| Malteurop Light | 0.288 | 0.314 | 0.356 | 0.386 |
| Coffee | | | | |

From the table, the red intensity values of Dark Crystal malt are in the range of 0.209-0.289 when the diluted chroma of the mashed wort is 60 and 70 EBC, and the mashed wort of Castle Special B malt also has a red intensity within the range when the diluted chroma is 50, 60 and 70 EBC. It can be seen that two or three corresponding red intensity values of the diluted mashed wort of the two malts are in the range of 0.209-0.289 at four chroma points in 50-80 EBC, indicating that the two malts are suitable for brewing red beer. Malteurop Light Coffee malt has a red intensity value in the range of 0.209-0.289 only when the diluted chroma of the mashed wort is 50 EBC, indicating that the malt can be used for brewing red beer, but is not preferred malt for brewing red beer.

The three special malts were matched with basic malt according to different proportions to brew beer, and the color results of the fermented bodies were analyzed, as shown in Table 6. Dark Crystal and Castle Special B malt can be in orange red, tomato red and brown red in three proportions, all of which are the most acceptable three red colors by assessors, further verifying that the two malts are suitable for brewing red beer. Malteurop Light Coffee malt can be used for brewing tomato red beer only when the proportion is 5.4%, and the colors of beer brewed according to the rest proportions are unacceptable red colors by the assessors, indicating that the malt has obvious limitation, and although it can be used for brewing red beer, it is not the preferred malt for brewing red beer. It can be seen that the experimental results show that the method of the present disclosure has good applicability.

TABLE 6
Fermentation results of three malts in different addition proportions

| | | Chroma/ | Color | |
|---|---|---|---|---|
| Malt Species | Proportion/% | EBC | description | Red intensity |
| Dark Crystal | 11.0 | 53 | Orange red | 0.217 |
| | 17.0 | 59 | Tomato red | 0.235 |
| | 23.0 | 70 | Brown red | 0.298 |
| Castle Special B | 5.0 | 49 | Orange red | 0.207 |
| | 7.5 | 56 | Tomato red | 0.223 |
| | 10.0 | 63 | Brown red | 0.251 |
| Malteurop Light | 5.4 | 49 | Tomato red | 0.222 |
| Coffee | 7.8 | 56 | Purple red | 0.281 |
| | 10.2 | 67 | Wine red | 0.332 |

It can be seen that the method of the present disclosure does not need to proportion and ferment malt, By only directly analyzing whether the red intensity of the diluted mashed wort corresponding to the malt is in the range of 0.209-0.289 when the chroma is 50-80 EBC, whether the malt can be used for brewing red beer may be determined. The method is simple and quick, is of important practical significance for guiding the production of red beer, and lays an important foundation for further brewing red beer with different malts.

The above-mentioned examples are better examples of the present disclosure, but are not restrictions on the examples of the present disclosure. In this field, any other changes, modifications, combinations, substitutions and simplifications that do not depart from the principles and spirit of the present disclosure belong to the equivalent replacement mode and are included in the scope of protection of the claims of the present disclosure.

What is claimed is:

1. A method for screening malt for brewing red beer, comprising the following steps:
(1) saccharifying malt to prepare mashed wort;
(2) diluting the mashed wort with water to a chromatic value of 50-80 EBC, and screening out the diluted mashed wort with a red intensity value of 0.209-0.289 to obtain a corresponding malt, wherein the corresponding malt is the malt for brewing the red beer; and the red intensity value is a ratio of parameters a* to b* in a CIE Lab color model.

2. The method according to claim 1, wherein the step (1) further comprises the following steps: crushing malt; taking and adding crushed malt grist to a mashing instrument; carrying out heat preservation at 40-50° C. for 20-50 min, heating to 65-80° C., carrying out heat preservation for 50-90 min, then cooling to room temperature; and adding water and filtering to obtain the mashed wort.

3. The method according to claim 1, wherein the step (1) comprises the following steps: crushing malt; taking and adding crushed malt grist to a mashing instrument; carrying out heat preservation at 45° C. for 30 min, heating to 70° C., carrying out heat preservation for 60 min, then cooling to room temperature; and adding water and filtering to obtain the mashed wort.

4. The method according to claim 1, wherein when the mashed wort is diluted with water to chromatic values of 50, 60, 70 and 80 EBC, respectively, red intensity values of the diluted mashed wort with the chromatic values of 50, 60, 70 and 80 EBC are determined, respectively, and if two or more of the four red intensity values fall within a range of 0.209-0.289, the corresponding malt is obtained.

5. The method according to claim 2, wherein when the mashed wort is diluted with water to chromatic values of 50, 60, 70 and 80 EBC, respectively, red intensity values of the diluted mashed wort with the chromatic values of 50, 60, 70 and 80 EBC are determined, respectively, and if two or more of the four red intensity values fall within a range of 0.209-0.289, the corresponding malt is obtained.

6. The method according to claim 1, wherein a heating rate is 1° C./min.

7. A method for brewing red beer, comprising steps of proportioning malt, preparing mashed wort, and inoculating beer yeast for fermentation, wherein the step of proportioning the malt is carried out by mixing special malt with light malt according to different proportions, so that the mashed wort has a chromatic value of 50-80 EBC and a red intensity value of 0.209-0.289; and the red intensity value is a ratio of parameters a* to b* in a CIE Lab color model.

8. The method according to claim 7, wherein the special malt is the malt screened by the method according to claim 1.

9. The method according to claim 7, wherein the step of inoculating the beer yeast for fermentation comprises: adding proportionally mixed malt grist to 48° C. water, wherein a ratio of raw material to water is 1:4.5; during saccharifying, carrying out heat preservation at 48° C. for 30 min, heating to 63° C. and carrying out heat preservation for 60 min, heating to 72° C. and carrying out heat preservation for 20 min, and finally heating to 78° C. and carrying out heat preservation for 10 min; filtering the wort after saccharifying; boiling the filtered wort for 70 min, and adding hops during boiling; carrying out secondary filtration after boiling; adding a certain amount of water to the filtered wort; detecting and adjusting a concentration of the wort by using an Abbe refractometer, so that the concentration of the wort is adjusted to 11° Bx, wherein a beer yeast inoculation amount at the start of fermentation is 1×10⁷/mL of mixed wort; and fermenting at 11° C. for 7 days.

10. The method according to claim 7, wherein the step of inoculating the beer yeast for fermentation comprises: adding proportionally mixed malt grist to 48° C. water, wherein a ratio of raw material to water is 1:4.5; during saccharifying, carrying out heat preservation at 48° C. for 30 min, heating to 63° C. and carrying out heat preservation for 60 min, heating to 72° C. and carrying out heat preservation for 20 min, and finally heating to 78° C. and carrying out heat preservation for 10 min; filtering the wort after saccharifying; boiling the filtered wort for 70 min, and adding hops during boiling; carrying out secondary filtration after boiling; adding a certain amount of water to the filtered wort; detecting and adjusting a concentration of the wort by using an Abbe refractometer, so that the concentration of the wort is adjusted to 11° Bx, wherein a beer yeast inoculation amount at the start of fermentation is 1×10⁷/mL of mixed wort; and fermenting at 11° C. for 7 days.

11. The method according to claim 9, wherein the hops are added three times, wherein ½ is added just after boiling, ¼ is added when boiling lasts for 30 min, the remaining ¼ is added 10 min before boiling ends, and a total amount of the added hops is 0.3 g/L.
